(19) United States
(12) Patent Application Publication
(10) Pub. No.: US 2004/0199644 A1
(43) Pub. Date: Oct. 7, 2004

(54) Method of assigning a virtual network identifier to a terminal, and a terminal, a dynamic host configuration server, and a directory server for implementing the method

(75) Inventors: Raymond Gass, Bolsenheim (FR); Michel Le Creff, Vigny (FR); Patrick Bastide, Bougival (FR); Marc Boullet, Colombes (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/701,621

(22) Filed: Nov. 6, 2003

(30) Foreign Application Priority Data
Nov. 8, 2002 (FR) 02 14 079

(51) Int. Cl. G06F 15/16

(52) U.S. Cl. 709/227

(57) ABSTRACT

The method assigns a terminal (IPP1) a virtual network identifier in a local area network (LAN) including a plurality of virtual networks (VLAN1, . . . , VLAN3) and a dynamic host configuration server (DHCPS). It consists in:

broadcasting throughout the network, from the terminal (IPP1), a message (M1) containing:

information on said terminal;

a request addressed to the dynamic host configuration server (DHCPS) and requesting in particular the assignment of a virtual network identifier for said terminal; and

a request addressed to the local node (ESW) of the terminal and requesting said node to supply indications as to the port of said node that is connected to said terminal by adding said indications to said message; and

deducing a virtual network identifier in the dynamic host configuration server (DHCPS), in particular from the information on said terminal, and sending said virtual network identifier to the terminal.

Application to telephone networks.

The invention relates in particular to a method of assigning a virtual network identifier to a terminal in a local area network conforming to the IEEE 802.1Q standard. This standard covers the definition, use, and administration of a local area network made up of a plurality of logical subnetworks referred to as virtual local area networks (VLAN). These logical subnetworks may use different technologies at the link level (Ethernet, Token Ring, etc.) and they are interconnected by bridges. Routers are additionally used to set up connections between terminals belonging to physical networks of any kind. The invention relates more particularly to local area networks using the Internet Protocol for routing; with the Ethernet, Token Ring, etc. protocol being used for connections.

Dividing a local area network into a plurality of virtual networks serves to define groups of terminals that can exchange data, regardless of the physical architecture of the network, and makes it possible, for security reasons, to restrict or prohibit the exchange of data between terminals belonging to different groups. It is also necessary to create at least one virtual local area network for using Voice over Internet Protocol telephones in a local area network also used for conventional transmission of data, for example between computers. A virtual network of this kind is called a voice virtual network and provides a particular way of processing data frames exchanged by the telephone terminals; the telephone terminals access dedicated servers for telephone services, and voice data packets require high transmission quality, since they cannot tolerate excessively long transmission delays.

To use virtual networks, a bridge must be able to tell to which virtual network the frame belongs each time it receives a frame. The IEEE 802.1Q standard defines a frame for explicitly distinguishing a plurality of virtual networks.

When a new machine is connected to a local area network including a plurality of virtual networks, it is necessary to assign that machine an Internet address and a virtual network identifier. The prior art Dynamic Host Configuration Protocol (DHCP) is used to initialize and configure dynamically a machine newly connected to a network using the Internet Protocol implemented by running server software in one of the machines of the network, called the DHCP server, and by running client software in the other machines of the network, called DHCP clients.

When a machine is started up in the network, its DHCP client broadcasts to all or part of the network a packet containing a DHCP request that signals the presence of the new machine to the DHCP server, which chooses an Internet address from the unassigned addresses in a predetermined batch of addresses. The DHCP server supplies that address to the new machine for a predetermined time period, at the end of which the server regards the address as free and uses it again for another machine if the machine concerned has not sent any messages to the DHCP server in the meantime to request assignment of an Internet address again.

According to the IETF document RFC 2131, the DHCP supplies to each machine:

a transaction reference,

an Internet address,

information on the time for which that Internet address is assigned,

the Internet address of the next server to use to start up the machine, and

a field of optional parameters.

Two methods of assigning a virtual network identifier are known in the art. A first method consists in configuring each machine manually to indicate its virtual network address to it. This necessitates a great deal of work and travel time if there are many machines. A second prior art method consists in manually configuring each of the Ethernet switches of the local area network to indicate to it a virtual network identifier for each terminal whose presence is detected by the switch. An administrator chooses the virtual network identifier as a function of:

a Medium Access Control address specific to the terminal, and

the terminal type.

That second method has the drawback of necessitating manual intervention at the local Ethernet switch for each new machine, and the manipulation of low-level information, a process prone to error.

The object of the invention is to simplify even further the procedure for installing a new machine.

The invention provides a method of assigning a terminal a virtual network identifier in a local area network including a plurality of virtual networks and a dynamic host configuration server, which method is characterized in that it consists in:

broadcasting throughout the network, from the terminal, a message containing:

information on said terminal;

a request addressed to the dynamic host configuration server and requesting in particular the assignment of a virtual network identifier for said terminal; and

deducing a virtual network identifier in the dynamic host configuration server, in particular from the information on said terminal, and sending said virtual network identifier to the terminal.

The method so characterized simplifies the procedure for installing a new machine because the dynamic host configuration server (DHCP server) determines a virtual network identifier automatically and supplies it to the new machine. The identifier is deduced from information on the terminal contained in the message broadcast by the terminal. For example, if it is a Voice over Internet Protocol terminal, it is assigned a voice virtual network identifier.

In one particular embodiment, the message further includes a request addressed to the local node of the terminal and requesting said node to supply indications as to the port of said node that is connected to said terminal by adding said indications to said message, and said method consists in deducing a virtual private network identifier in the dynamic host configuration server from the indications as to the port and the information on the terminal.

The method so characterized automatically assigns a virtual network identifier with additional criteria related to the location of the terminal, which is obtained from indications as to the local node of the terminal and the attachment port to that node, these indications being collected by the message when it passes through the connection node on its way from the terminal to the DHCP server. For example, the location information indicates that the terminal is in a place where all the telephones belong to a particular virtual network, for example are specific to an administration department.

In one particular embodiment, the method according to the invention further consists in interrogating a directory server on the basis of information on the terminal to deduce a virtual network identifier therefrom as a function of information on a user of the terminal.

The method so characterized automatically assigns a virtual network identifier with criteria that are even further refined, because they are tied to the functions of the user, not only to the location of the terminal and to the terminal type.

The invention also consists in a terminal, a dynamic host configuration server, and a directory server for implementing the above method.

The invention will be better understood and other features will become apparent in the course of the following description and from the accompanying drawings:

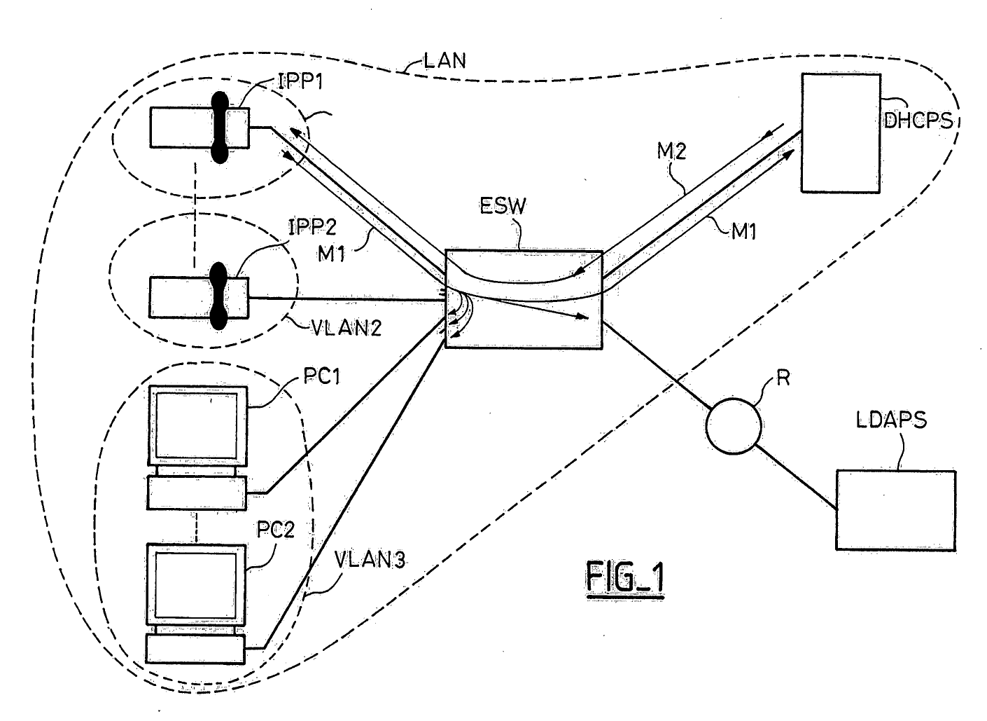

FIG. 1 shows an example of a local area network in which the method of the invention is used.

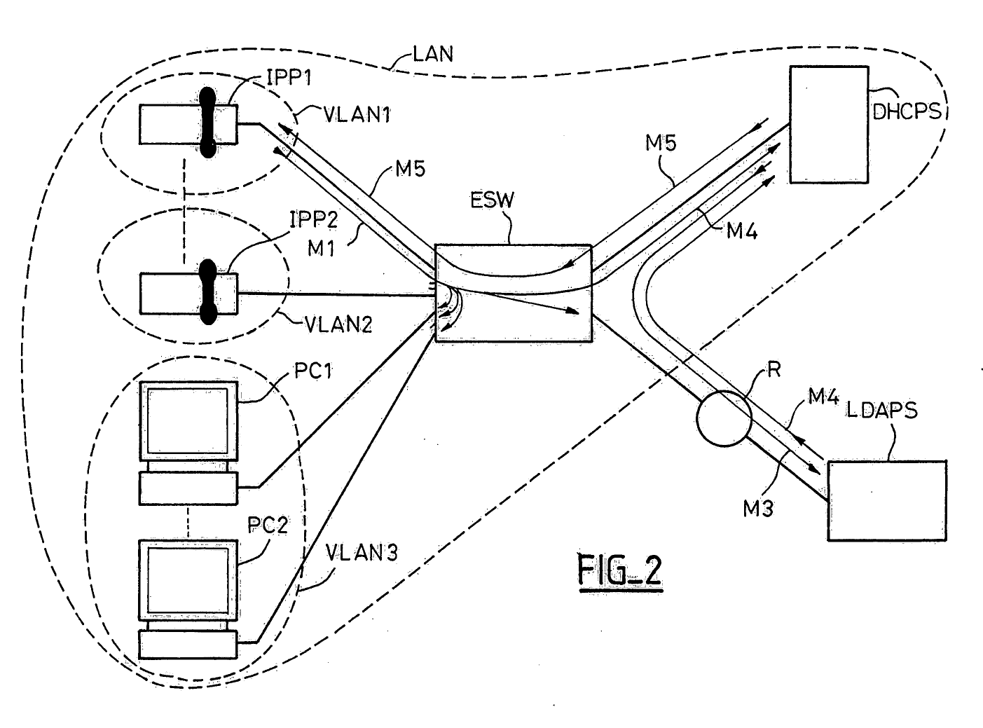

FIG. 2 shows a different embodiment of the method of the invention, in the same local area network, but using a directory server.

In FIG. 1, the local area network LAN is used for telephony in two voice virtual networks which correspond to two separate departments within a company, for example, and is also used to transmit data in a data virtual network. It includes:

A voice virtual network LAN1 comprising voice terminals IPP1, etc. in the form of Voice over Internet Protocol telephones, or other data processing machines having functions including the Voice over Internet Protocol function, for example personal computers running telephony software.

A voice virtual network LAN2 comprising voice terminals IPP2, etc. in the form of Voice over Internet Protocol telephones, or other data processing machines having functions including the Voice over Internet Protocol function, for example personal computers running telephony software.

A data virtual network LAN3 comprising data processing machines PC1, . . . , PC2 that do not process voice, for example personal computers used only for data processing applications.

A dynamic host configuration server DHCPS utilizing the prior art Dynamic Host Configuration Protocol (DHCP) modified in accordance with the invention.

A conventional Ethernet switch ESW connected to all the preceding elements by Ethernet connections.

The Ethernet switch ESW is connected, outside the local area network LAN, to a directory server LDAPS via a router R. The directory server LDAPs services a plurality of sites of a company, for example, and uses the conventional LDAP modified in accordance with the invention.

When a voice terminal, for example the terminal IPP1, is started up, it broadcasts a message M1 via the switch ESW1 to all the nodes of the network LAN. The message M1 reaches the dynamic host configuration server DHCPS in particular.

In a preferred embodiment, the message M1 is a conventional DHCP mode 82 request containing:

the Medium Access Control address of the terminal IPP1;

a request addressed to the host dynamic configuration server DHCPS and in particular requesting it to assign a virtual network identifier for this terminal; and

a request addressed to the local node of the terminal and requesting that node to supply indications as to the port of that node that is connected to the terminal concerned by adding those indications to the message M1.

However, according to the invention, the message M1 further contains (in the optional parameters field) information on the terminal IPP1 to indicate the terminal type, in this instance to indicate that the terminal IPP1 is a Voice over Internet Protocol telephone.

In this network example, the local node of the terminal IPP1 is the switch ESW. This switch adds to the content of the message its own Medium Access Control address and the number of the port at which it received the message. When the message M1 reaches the server DHCPS, the server interprets this mode 82 request and assigns a free Internet address and a virtual network identifier that is a function of all of the information contained in the message M1:

It can be deduced from the terminal type that the terminal IPP1 must belong to a voice virtual network: VLAN1 or VLAN2.

The location of the terminal can be deduced from the topological information. For example, the two virtual networks VLAN1 and VLAN2 correspond to two groups of ports of the switch ESW respectively connected to the offices of two separate departments of the company concerned. From a predetermined table establishing the correspondence between the port numbers of the switch ESW and the virtual network addresses VLAN1 and VLAN2, the server DHCPS deduces a virtual network identifier for the terminal IPP1 (the identifier VLAN1 in this example). The server DHCPS then sends the terminal IPP1 a DHCP mode 82 acknowledgment message M2 containing the Internet address, in a manner that is known in the art, and additionally containing, in accordance with the invention, the virtual network identifier (VLAN1). The terminal IPP1 stores the Internet address and the virtual network identifier that are assigned to it in this way.

Knowing the terminal type, the same method is used to assign an Internet address and a virtual network identifier VLAN3 to a terminal PC1, . . . , PC2 dedicated exclusively to data processing.

In a simplified embodiment, the message M1 is a conventional DHCP request that is not in mode 82, in other words that contains:

the Medium Access Control address of the terminal IPP1; and

an option requesting a virtual network identifier for the terminal.

It contains no request for the local node to supply indications as to the port of that node that is connected to the terminal by adding such indications to the message. However, in accordance with the invention, the message M1 additionally contains information on the terminal IPP1 to indicate the terminal type, in this instance that it is a Voice over Internet Protocol telephone. A virtual network identifier is then assigned as a function of only the terminal type: voice or data. It is no longer possible to distinguish between the voice virtual networks VLAN1 and VLAN2. There is only one voice virtual network.

In other embodiments, the message M1 can contain more information about the terminal:

The precise nature of the terminal (a Voice over Internet Protocol telephone, specifying landline or cordless; a personal digital assistant, specifying that it includes a radio link supporting a voice type Bluetooth link, for example; a computer on which telephony software has been installed; etc.).

Manufacturer.

Equipment version (hardware or software).

Old virtual network identifier, where applicable.

Name of the usual user of the terminal.

The additional information field in the DHCP message provides an opening to a large number of new services for transmission of data and telephony:

Mobility.

Easy configuration for network managers (data and telephony).

With certain terminals offering more than one type of communication (voice and data alternately), the virtual network identifier request can be submitted at a time other than that of connection to the network. For example:

on power up, a personal computer requests a given Internet address and a given virtual network identifier;

at some other time (that need not correspond to a power up), it sends another request to obtain a voice virtual network identifier.

When assigning the voice virtual network identifier, the server DHCPS can:

send only the voice virtual network identifier; in this case, the computer uses the Internet address already assigned;

or send, in addition to the voice virtual area network, the Internet address already assigned for the data service, or some other Internet address.

Two modes of operation are possible:

either the same Internet address for the data service and the voice service;

or different Internet addresses for the data service and the voice service.

In the above description, it is assumed that the server DHCPS knows the information needed to send the virtual network identifiers (voice and data) to the terminal. This information can be entered into the server DHCPS in various ways:

An operator enters the information directly into the server DHCPS, either manually or using a memory medium (diskette, CD-ROM, etc.).

The server DHCPS being itself in a network, another server of that network can send it the information, for example a directory server containing a great deal of information relating to the users of the network (name, telephone number, Internet address, terminal types, function within the company—manager, secretary, marketing, R&D, production engineering, etc.).

The directory server LDAPS can update the information of the server DHCPS at the time of exchanges between the servers. It is also possible, each time the server DHCPS is invoked by a terminal, for the server DHCPS to interrogate the server LDAPS to obtain the information to be sent to the terminal. These exchanges between servers significantly reduce human intervention for the purposes of configuration (avoiding entry errors and a workload).

FIG. 2 shows a variant of the method according to the invention, in the same local area network LAN, but using the directory server LDAPS. When it receives the message M1 previously described, the server DHCPS interrogates the server LDAPS by means of a message M3 containing the Medium Access Control address of the terminal extracted from the message M1, that address being associated with a user name and with the functions of the user in a directory. The server LDAPS responds with a message M4 indicating the functions of the user. The server DHCPS deduces therefrom a virtual network identifier corresponding to those functions. It sends the terminal IPP1 a mode 82 message M5 containing the Internet address and the virtual network identifier assigned to the terminal IPP1.

In one embodiment, the server LDAPS supplies a virtual network identifier directly from the Medium Access Control address of the terminal and sends that identifier to the dynamic host configuration server DHCPS.

The method according to the invention is applicable in an analogous manner to other networks including a greater number of switches as well as bridges and routers.

1. A method of assigning a terminal (IPP1) a virtual network identifier in a local area network (LAN) including a plurality of virtual networks (VLAN1, . . . , VLAN3) and a dynamic host configuration server (DHCPS), which method is characterized in that it consists in:
broadcasting in the network, from the terminal (IPP1), a message (M1) containing:
information on said terminal;
a request addressed to the dynamic host configuration server (DHCPS) and requesting in particular the assignment of a virtual network identifier for said terminal; and
deducing a virtual network identifier in the dynamic host configuration server (DHCPS), in particular from the information on said terminal, and sending said virtual network identifier to the terminal.

2. A method according to claim 1, characterized in that the message (M1) further includes a request addressed to the local node (ESW) of the terminal and requesting said node to supply indications as to the port of said node that is connected to said terminal by adding said indications to said message; and
in that it consists in deducing a virtual private network identifier in the dynamic host configuration server (DHCPS) from the indications as to the port and the information on the terminal.

3. A method according to claim 1, characterized in that it further consists in interrogating a directory server (LDAPS) on the basis of information on the terminal to deduce a virtual network identifier therefrom as a function of information on a user of the terminal.

4. A dynamic host configuration server (DHCPS) for a local area network including a plurality of virtual networks (VLAN1, . . . , VLAN3), characterized in that it includes:
means for receiving a message coming from a terminal, said message containing:
information on said terminal; and
a request in particular for the assignment of a virtual network identifier for said terminal; and
means for deducing a virtual network identifier, in particular from the information on said terminal, and sending said virtual network address to the terminal.

5. A dynamic host configuration server (DHCPS) according to claim 4, characterized in that it includes:
means for receiving a message coming from a terminal, said message containing:
information on said terminal; and
a request in particular for the assignment of a virtual network identifier for said terminal; and
indications as to the port of said node that is connected to said terminal; and
means for deducing a virtual network identifier from said indications as to the port and the information on said terminal and then sending said virtual network address to the terminal.

6. A directory server (LDAPS) adapted to be connected to a local area network (LAN) including a plurality of virtual networks (VLAN1, . . . , VLAN3), characterized in that it includes:
means for receiving a message coming from a dynamic host configuration server (DHCPS) belonging to said local area network and containing information on the terminal (IPP1); and
means for deducing a virtual network identifier from said information on the terminal name and sending said virtual network identifier to said dynamic host configuration server (DHCPS).

7. A directory server (LDAPS) adapted to be connected to a local area network (LAN) including a plurality of virtual networks (VLAN1, . . . , VLAN3), characterized in that it includes:
means for receiving a message (M3) coming from a dynamic host configuration server (DHCPS) belonging to said local area network and containing information on the terminal (IPP1); and
means for supplying information on a user on the basis of the information on the terminal and sending (M4) said information on a user to said dynamic host configuration server (DHCPS).

8. A terminal (IPP1) for a local area network (LAN) including a plurality of virtual networks (VLAN1, VLAN3), characterized in that it includes means for broadcasting in said local area network a message (M1) addressed to a dynamic host configuration server (DHCPS) and containing:
information on said terminal; and
a request in particular for the assignment of a virtual network identifier for said terminal.

9. A terminal (IPP1) according to claim 8, characterized in that it includes means for broadcasting in said local area network a message (M1) addressed to a dynamic host configuration server (DHCPS) and containing:
information on said terminal;
a request in particular for the assignment of a virtual network identifier for said terminal; and
a request addressed to the local node (ESW) of the terminal and requesting said node to supply indications as to the port of said node that is connected to said terminal by adding said indications to said message.
